(19) United States
(12) Patent Application Publication
(10) Pub. No.: US 2012/0163851 A1
(43) Pub. Date: Jun. 28, 2012

(54) IMAGE FORMING APPARATUS AND METHOD OF CONTROLLING SAME

(75) Inventor: Yuka Masuyama, Tokyo (JP)

(73) Assignee: CANON KABUSHIKI KAISHA, Tokyo (JP)

(21) Appl. No.: 13/323,462

(22) Filed: Dec. 12, 2011

(30) Foreign Application Priority Data
Dec. 24, 2010 (JP) 2010-288553

(51) Int. Cl. G03G 15/00

(52) U.S. Cl. 399/81; 399/82

(57) ABSTRACT

When an image is formed on paper, which has been placed in paper feed cassettes (hereinafter called cassettes), in accordance with paper information concerning a cassette specified by a print job and a job ticket, the paper information concerning the specified cassette is compared with paper information that has been set for the cassettes. A cassette for which has been set paper information that matches the paper information concerning the specified cassette is held temporarily as a cassette for which a change of paper is unnecessary. The specified information is overwritten regarding a cassette, from among cassettes different from the temporarily held cassette, for which has been set a paper size that matches the paper size of the specified paper information. A display is presented for allowing the specified paper information to be changed to paper of the specified paper information regarding the overwritten cassette.

### BACKGROUND OF THE INVENTION

1. Field of the Invention

The present invention relates to an image forming apparatus and to a method of controlling this apparatus.

2. Description of the Related Art

In the case of an image forming apparatus having multiple paper feed trays, generally it is required that the user register the paper used in each paper feed tray from a setting screen on the main body of the apparatus. In a case where there are many paper feed trays connected or many types of paper used in a single print job, it is time-consuming for the user to make the paper registration setting for every paper feed tray and experience in doing so is required as well.

Further, when a job is a variable data printing (VDP) job, there are instances where different paper is used for every record or where multiple types of paper are used within one record. In such cases, therefore, a paper registration operation occurs often and this has an impact upon operation time.

Accordingly, in order to improve operating efficiency by eliminating the paper registration operation, it has heretofore been proposed to generate an out-of-paper error after a job is introduced and, when the error occurs, overwrite paper feed trays with the paper feed trays that have been set for the job and with paper information. (For example, see the specification of Japanese Patent Laid-Open No. 2006-337410, referred to as “Patent Document 1” below).

According to the technique described in Patent Document 1, the user is alerted if the paper information for the job fails to match the paper information for the designated paper feed trays after the job is introduced. Print processing is allowed to continue in accordance with paper information specified by the job after withdrawal of a designated paper feed tray is sensed following the issuance of the alert. In accordance with the technique described in Patent Document 1, print processing can be continued without the user resetting the paper information of a paper feed tray every time. User convenience is improved as a result.

With the technique described above, however, withdrawal of a paper feed tray (paper feed cassette) is sensed following issuance of the alert and print processing is allowed to continue in accordance with the paper information specified by the print job. This means that the user is required to monitor printing at all times and to deal with alert processing the generation timing of which is unknown.

Further, only paper information specified by the print job and paper information concerning a specified paper feed cassette is compared and whether the two items of paper information are the same is determined. Consequently, paper information that has already been set for other paper feed cassettes is not taken into account, and even if a specified paper has already been set in paper feed cassette in additions to a specified paper feed cassette, the user is required to switch the paper of the paper feed cassette specified by the print job. This results in a needless operation.

### SUMMARY OF THE INVENTION

The present invention provides an image forming apparatus and method of controlling the same in which the setting of a paper feed cassette can be overwritten in optimum fashion with the paper information in a print job without interrupting printing and by taking into consideration the paper information of other paper feed cassettes before the execution of processing for overwriting paper feed cassettes.

In accordance with the present invention, there is provided an image forming apparatus for forming an image on paper, which has been placed in a plurality of paper feed cassettes of the image forming apparatus, in accordance with paper information concerning a paper feed cassette specified by a print job and a job ticket, comprising: a holding unit that compares the paper information concerning the paper feed cassette specified by the job ticket and paper information that has been set for the plurality of paper feed cassettes, and to hold temporarily, as a paper feed cassette for which a change of paper is unnecessary, a paper feed cassette for which has been set paper information that matches the paper information concerning the specified paper feed cassette; an overwrite unit that overwrites the specified paper information with respect to a paper feed cassette, from among paper feed cassettes different from the temporarily held paper feed cassette, for which has been set a paper size that matches the paper size of the specified paper information; and a display control unit that presents a display for allowing the specified paper information to be changed to paper of the specified paper information with respect to the overwritten paper feed cassette.

Further features of the present invention will become apparent from the following description of exemplary embodiments (with reference to the attached drawings).

### BRIEF DESCRIPTION OF THE DRAWINGS

FIG. 1 is a block diagram illustrating an example of the basic configuration of an image forming system;

FIG. 2 is a block diagram illustrating the basic configuration of an image forming apparatus;

FIG. 3 is a diagram illustrating an example of a print job X and a job ticket Y;

FIG. 4 is a diagram illustrating an example of paper information 401 before overwrite, paper information 402 of a job ticket, and a paper feed cassette setting 403 after overwrite;

FIG. 5 is a flowchart illustrating a series of processing steps from receipt of a print job to start of printing;

FIG. 6 is a flowchart illustrating the details of processing (step S504) for detecting the setting of a paper feed cassette;

FIG. 7 is a diagram illustrating paper information in a storage unit storing paper feed cassette settings, overwrite-request data and paper information retained temporarily;

FIG. 8 is a diagram illustrating an example of a settings screen for setting whether or not to permit the setting of overwrite of paper information of a paper feed cassette;

FIG. 9 is a diagram illustrating an example of a paper feed cassette setting in which the paper setting of a paper feed cassette is overwritten and displayed on a touch-sensitive panel;

FIG. 10 is a flowchart illustrating a series of processing steps according to a second embodiment of the present invention;

FIG. 11 is a flowchart illustrating the details of processing for detecting an additional paper feed cassette;

FIG. 12 is a diagram illustrating an example of a received print job X and job ticket according to the second embodiment;

FIG. 13 is a flowchart illustrating processing for restoring a paper feed cassette setting to that which was in effect before overwrite; and

FIG. 14 is a flowchart illustrating processing for restoring a paper feed cassette setting to the original following print processing.

### DESCRIPTION OF THE EMBODIMENTS

Embodiments of the present invention will be described in detail with reference to the drawings. In these embodiments, a digital multifunction peripheral having various functions such as scanning, printing and copying functions will be described as an example of an image forming apparatus.

### First Embodiment

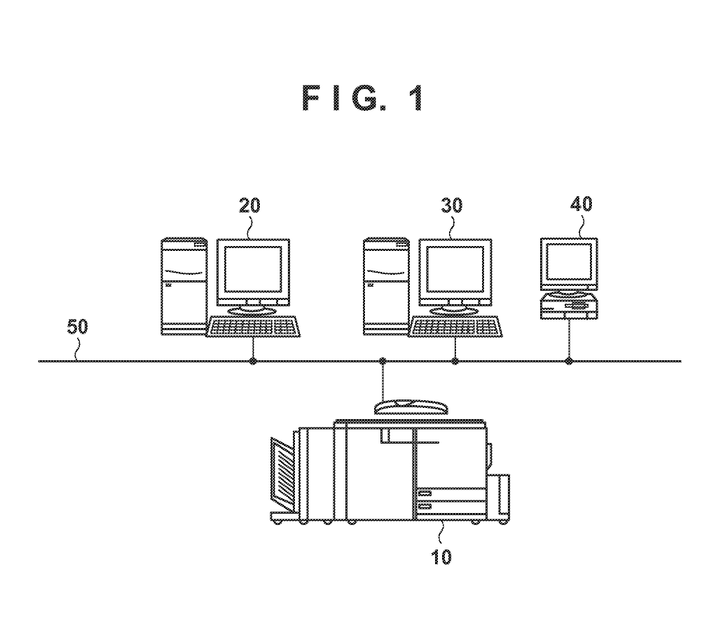

FIG. 1 is a block diagram illustrating an example of the basic configuration of an image forming system according to a first embodiment of the present invention. The image forming system has an image forming apparatus 10, a print server 20, a file server 30 and a client personal computer 40. The image forming apparatus 10, print server 20, file server 30 and client personal computer 40 are connected via a network 50 such as a LAN or WAN so as to be capable of communicating with one another.

The print server 20 manages an entered print job and the image forming apparatus 10, which has been connected via the network 50. The print server 20 is capable of monitoring the connected image forming apparatus 10 and the status of all print jobs and can execute processing such as temporarily halting a print job, changing settings, resuming printing and duplicating, moving and deleting print jobs.

The file server 30 stores a database of variable data used in variable data printing (VDP), for example, a customer database comprising destinations, addresses and names. The client personal computer 40 has functions for compiling application files and specifying printing. The client personal computer 40 further has a function for assisting in the monitoring and control of the image forming apparatus 10, which is managed by the print server 20, and print jobs. The user can check print-job status or the like by utilizing the client personal computer 40.

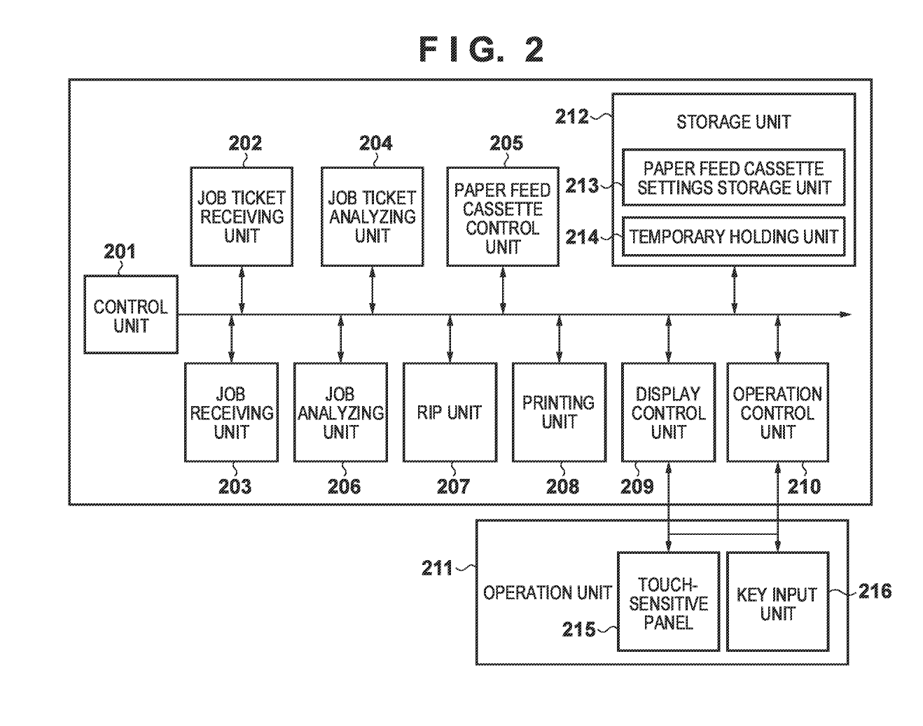

FIG. 2 is a block diagram illustrating the basic configuration of the image forming apparatus 10. A control unit 201 controls functions (units) that have been connected via a system bus and controls the overall operation of the image forming apparatus 10. The control unit 201 controls the units of the image forming apparatus 10 by executing a program that has been stored in a storage unit 212.

A operation unit 211, which is for allowing the user to make various inputs, is constituted by a touch-sensitive panel 215 and a key input unit 216. An operation control unit 210 sends the control unit 201 information entered from the touch-sensitive panel 215 and key input unit 216. At the time an ordinary paper registration setting is made, the operation control unit 210 receives from the touch-sensitive panel 215 and key input unit 216 a paper registration and setting instruction for each paper feed cassette. A display control unit 209 controls various displays and an LED display, etc., on the touch-sensitive panel 215. The display control unit 209 causes the touch-sensitive panel 215 to display an indication to switch a paper feed cassette thereby notifying the user.

A job ticket receiving unit 202 receives a job ticket entered via the print server 20 in response to a print command from the client personal computer 40 and transmits the received job ticket to a job ticket analyzing unit 204. The job ticket analyzing unit 204 analyzes settings information, which relates to the paper feed cassettes, described in the job ticket received from the job ticket receiving unit 202 and sends a paper feed cassette control unit 205 information necessary for a paper feed cassette overwrite setting specified by the job ticket.

A job receiving unit 203 receives a print job entered via the print server 20 in response to a print command from the client personal computer 40 and transmits the received print job to a job analyzing unit 206. The job analyzing unit 206 analyzes a print job received from the job receiving unit 203. When it performs analysis, the job analyzing unit 206 checks to determine whether the paper feed cassette overwrite setting is ON for the received print job. If the result of analysis is that the overwrite setting is ON, then the job analyzing unit 206 notifies the paper feed cassette control unit 205 of overwrite processing.

The storage unit 212 is constituted by a non-volatile large-scale memory such as a hard disk. Image data generated by processing, control information used by each unit and settings information are stored in the storage unit 212. Further, the storage unit 212 has paper feed cassette settings storage unit 213 and a temporary holding unit 214. Paper information indicating paper type and paper size set for the paper feed cassettes is stored in the paper feed cassette settings storage unit 213. A paper feed cassette and paper information held temporarily when overwrite processing of a paper feed cassette is decided is stored in the temporary holding unit 214.

The paper feed cassette control unit 205 compares and analyzes the paper information that has been stored in the paper feed cassette settings storage unit 213 and the paper information of each paper feed cassette indicated by the job ticket. The paper feed cassette control unit 205 detects whether the paper information of each paper feed cassette designated by the job ticket has already been set or whether the same paper information has been set for another paper feed cassette, and decides the optimum overwrite processing. In a case where the paper information differs from the paper information of a paper feed cassette processed by the job ticket, the optimum overwrite processing sends the job analyzing unit 206 and the job ticket analyzing unit 204 of a command to execute overwrite processing of the job ticket and print job together with information (paper feed cassette and paper information) necessary for the overwrite.

As a result of the foregoing, the job ticket analyzing unit 204 and job analyzing unit 206 execute overwrite processing of the print job and job ticket in accordance with the paper feed cassette and paper information received.

The image data of a print job is input to a RIP (Raster Image Processor) 207 by a command from the control unit 201, and the RIP 207 applies RIP processing to this image data. The image data that has been subjected to RIP processing in the RIP 207 is input to a printing unit 208, which proceeds to execute print processing. When print processing is executed, the printing unit 208 prints based upon the paper feed cassette for which overwrite has been set and the paper information thereof.

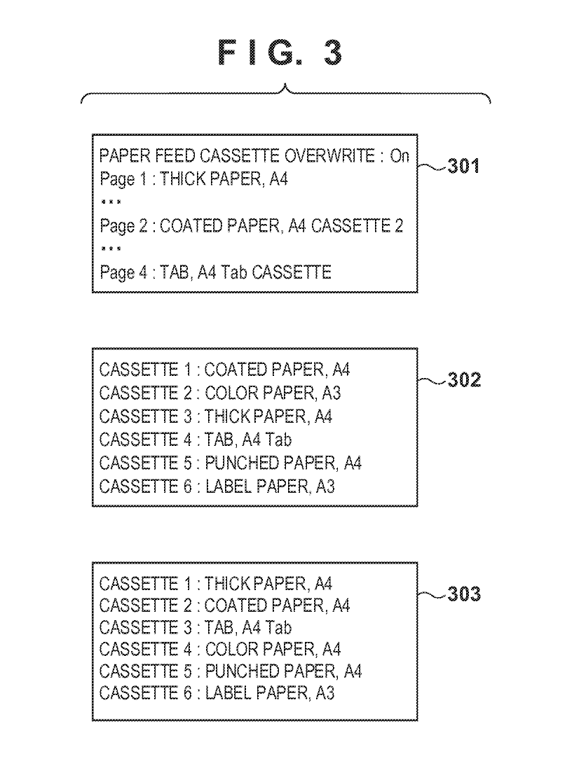

FIG. 3 is a diagram illustrating an example of a print job X and a job ticket Y. For a print job X 301, a “paper feed cassette overwrite” attribute, which designates a paper feed cassette overwrite setting, is ON. In a case where this setting is OFF, processing for overwriting paper information that has been set for a paper feed cassette is not executed by a paper feed cassette and paper information specified by the job ticket. Described in the print job X 301 are a paper feed cassette, paper size and paper type that have been designated for each page of the print job. In addition, information necessary for print processing is described in the print job X 301. In the described information, paper information designated for each page can be acquired as a result of the RIP 207 subjecting each page to RIP processing successively at the time of RIP processing.

In the prior art, when a print job is executed, whether the necessary paper has been placed in a paper feed cassette designated by execution of RIP processing is determined and, if there is a mismatch, the user is notified. Such processing is possible in the case of a print job for which the number of pages subject to RIP processing is small. However, in the case of a print job that includes tens of thousands of records, such as a VDP print job, executing RIP first and then determining whether the necessary paper is present according to the Rip Then Print method would lower productivity. Accordingly, even in the case of a VDP print job in which Rip While Print processing is executed, as in this embodiment, processing for analyzing the job ticket is executed in such a manner that the paper used can be detected in advance.

Information necessary when the user prints the print job X 301 is described in a job ticket Y 302 shown in FIG. 3. In this example, the necessary paper feed cassettes and paper information are described in the job ticket. Before the printing of the print job X 301 starts, the user can switch the paper required for paper feed cassettes.

A job ticket 303 after overwrite shown in FIG. 3 is such that optimum overwrite processing has been decided and, from among the paper feed cassettes designated by the job ticket Y 302, the settings remain as designated only for Cassettes 5 and 6, with the optimum settings having been rewritten for the other paper feed cassettes. As a result, the user can perform a paper switching operation in accordance with the cassettes and paper information of the job ticket 303 that has been subjected to overwrite processing.

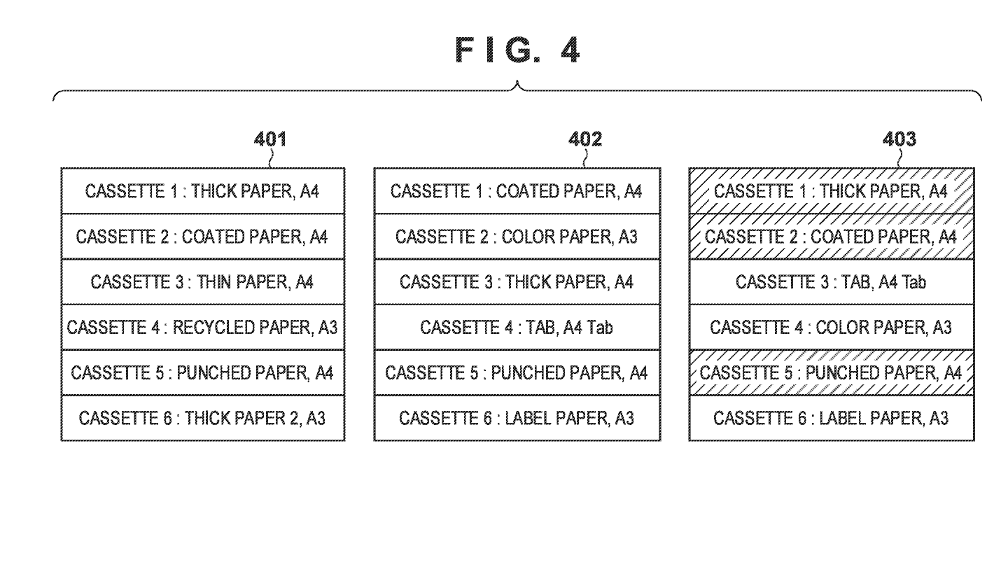

FIG. 4 is a diagram illustrating an example of paper information 401 before overwrite, paper information 402 of a job ticket, and a paper feed cassette setting 403 after overwrite. As shown in FIG. 4, the following has been set as the paper information 401 before overwrite: Cassette 1: thick paper, A4; Cassette 2: coated paper, A4; Cassette 3: thick paper, A4; Cassette 4: recycled paper, A3; Cassette 5: punched paper, A4; Cassette 6: thick paper 2, A3.

The following is indicated as the paper information 402 of the job ticket: Cassette 1: coated paper, A4; Cassette 2: color paper, A3; Cassette 3: thick paper, A4; Cassette 4: tab, A4 tab; Cassette 5: punched paper, A4; Cassette 6: label paper 2, A3.

Before overwrite processing is executed based upon the paper feed cassettes and paper information designated by the job ticket, whether a paper type and paper size the same as those of paper designated for overwrite have not been set in paper information that has been set for paper feed cassettes prior to overwrite are detected. If the result of detection is that paper of the same type and same size has already been set in another paper feed cassette, then optimum overwrite processing is executed by using this paper feed cassette preferentially. As a result, as shown in the paper feed cassette setting 403 after overwrite, the paper feed cassette settings of Cassettes 1, 2, 5 are not changed, the paper for paper feed cassettes is switched only for Cassettes 3, 4, 6, and overwrite processing is executed.

In the prior art, paper feed cassette settings in effect prior to overwrite processing are not taken into account. Consequently, in the case of the example shown in FIG. 4, it is necessary to switch all of the paper feed cassettes in accordance with the overwrite specifications of the job ticket. This means that the paper of all of the paper feed cassettes is switched irrespective of the fact that the same paper has already been set in another paper feed cassette. With the present embodiment, on the other hand, printing can be started with the minimum necessary switching of paper.

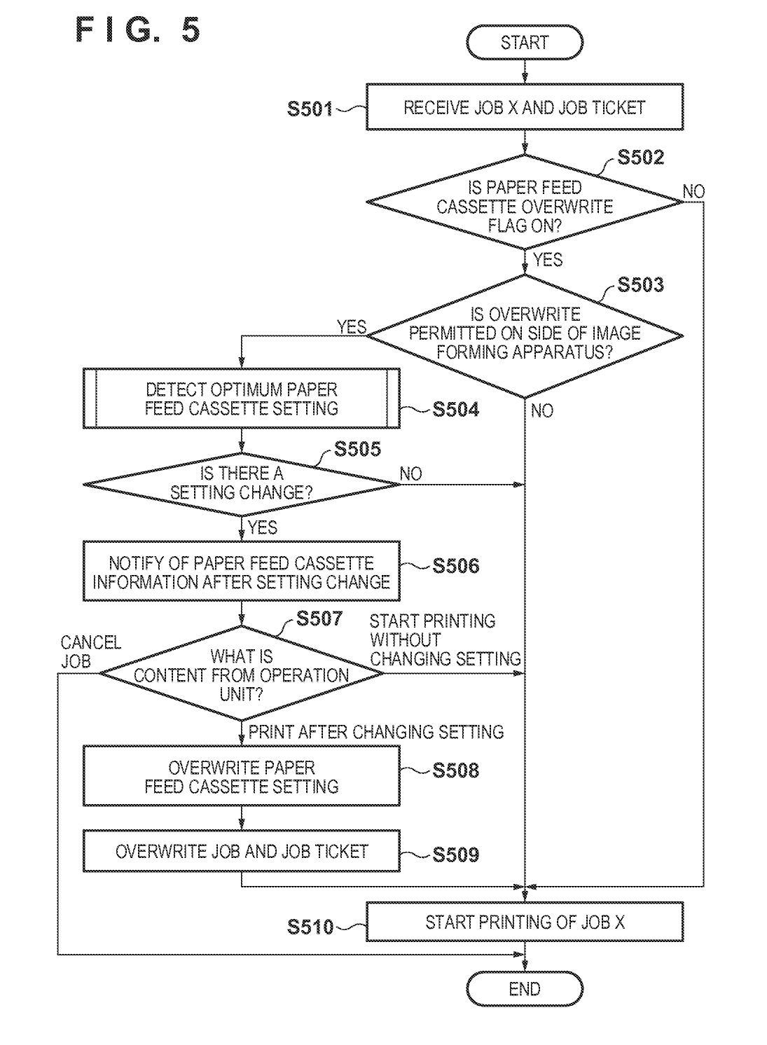

FIG. 5 is a flowchart illustrating a series of processing steps from receipt of a print job to start of printing. At step S501, the job receiving unit 203 and job ticket receiving unit 202 receive a print job and a job ticket and send these to the job analyzing unit 206 and job ticket analyzing unit 204, respectively. At step S502, the job analyzing unit 206 analyzes the received print job and determines whether the paper feed cassette overwrite setting, which is one printing attribute, has been designated to be ON. If a paper feed cassette overwrite flag has been set to the ON state, control proceeds to step S503. On the other hand, if the paper feed cassette overwrite flag has been set to the OFF state, paper feed cassette overwrite processing is not executed and control proceeds to step S510 in order to execute ordinary print processing.

At step S503, the paper feed cassette control unit 205 determines whether the image forming apparatus is permitting paper feed cassette overwrite. Permission for paper feed cassette overwrite is designated by the user from the operation unit 211, and the operation unit 211 notifies the paper feed cassette control unit 205 of this setting that permits paper feed cassette overwrite. Control proceeds to step S504 if paper feed cassette overwrite has been permitted. If paper feed cassette overwrite has not been permitted, then control proceeds to step S510 in order to execute ordinary print processing.

More specifically, the overwriting of the setting of a paper feed cassette with content designated by the job ticket is permitted only if overwrite processing has been designated with respect to the print job at step S502 and, moreover, overwrite has been permitted with regard to the image forming apparatus at step S503. The reason for this is to prevent errors such as the occurrence of jamming ascribable to execution of inadvertent overwrite processing and mismatch between paper information that will be overwritten and paper that has actually been placed in the paper feed cassette.

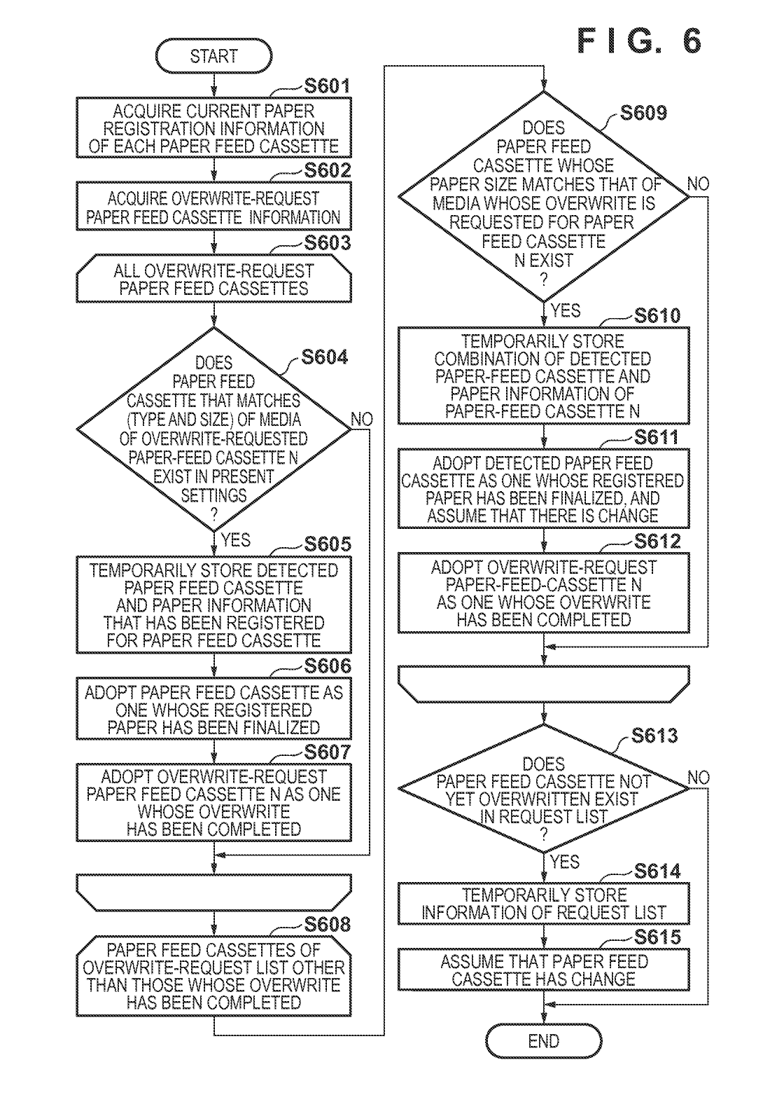

At step S504, the paper feed cassette control unit 205 detects the optimum paper feed cassette overwrite setting using the received job ticket and the paper feed cassette paper information that was in effect before overwrite. The details of setting detection processing will be described later with reference to FIG. 6.

Next, at step S505, the paper feed cassette control unit 205 determines whether it is necessary to change the registered paper setting of the paper feed cassette, the setting having been detected at the processing of step S504. If it is determined that it is necessary to change the registered paper setting of the paper feed cassette, control proceeds to step S506. If it is determined that a change is not necessary, then control proceeds to step S510.

At step S506, the paper feed cassette control unit 205 notifies the display control unit 209 of the change of the registered paper setting. From the paper feed cassette control unit 205 the display control unit 209 receives notification of a paper feed cassette change request, the paper feed cassette whose paper is to switched, and this paper information. The display control unit 209 displays the received information on the touch-sensitive panel 215 to thereby notify the user. FIG. 9 is a diagram illustrating an example of a paper feed cassette setting in which the paper setting of a paper feed cassette is overwritten and displayed on the touch-sensitive panel 215. It should be noted that a paper feed cassette setting 902 on a paper feed cassette setting screen 901 is the paper feed cassette setting 403 after overwrite shown in FIG. 4.

Next, at step S507, the operation control unit 210 inputs an indication of the next processing step from the touch-sensitive panel 215. If the input indication is cancellation of the print job (namely cancellation of printing), the processing of this flowchart is terminated. On the other hand, if printing following switching of the paper feed cassette (namely printing after overwrite) is indicated by the information of which notification has been given, then control proceeds to step S508. At this time the user receives the change notification and, after the change of setting is made, performs an operation to switch the paper of the paper feed cassette, of which notification has been given, by the time execution of printing is instructed. Further, if an indication to start printing without changing the paper feed cassette overwrite setting (namely printing without overwrite) is received, then control proceeds to step S510. It should be noted that the details of printing after overwrite, printing without overwrite and cancellation of printing will be described later with reference to FIG. 9.

At step S508, the paper feed cassette control unit 205 overwrites the registered paper information of the paper feed cassette with the optimum paper feed cassette information detected. At step S509, the job analyzing unit 206 and job ticket analyzing unit 204 receive from the paper feed cassette control unit 205 the information of the paper feed cassette used and overwrite the paper feed cassette and paper information of the print job and job ticket.

At step S510, the control unit 201 notifies the RIP 207 and printing unit 208 of start of print processing, and print processing begins. It should be noted that the print processing by the RIP 207 and printing unit 208 is well-known art and is not described here.

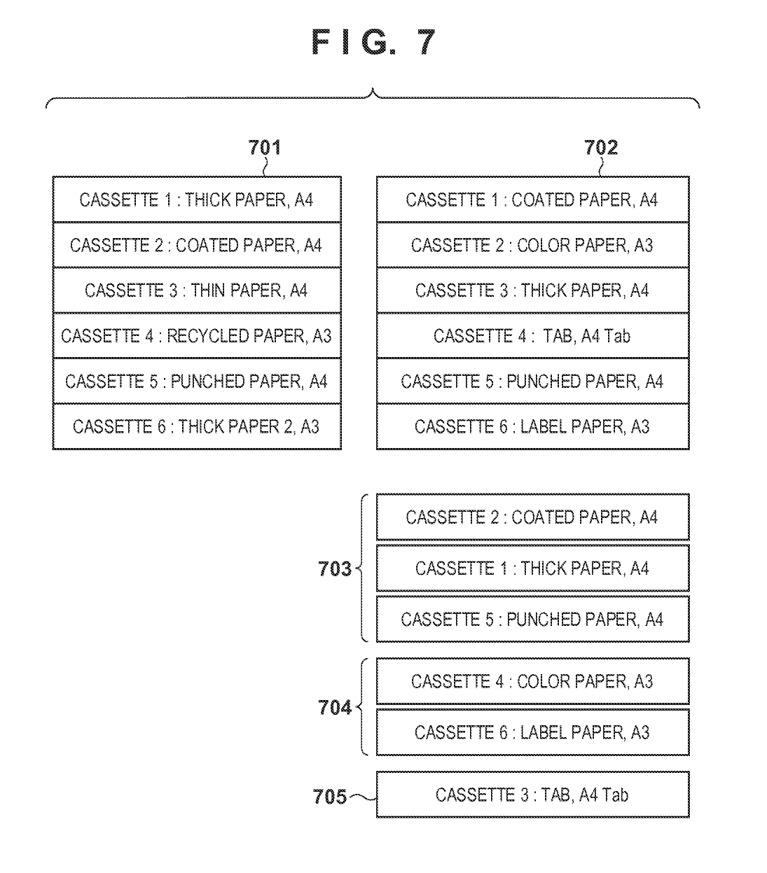

FIG. 6 is a flowchart illustrating the details of processing (step S504) for detecting the optimum paper feed cassette setting. Further, FIG. 7 is a diagram illustrating paper information in a storage unit storing paper feed cassette settings, overwrite-request data and paper information retained temporarily.

First, at step S601, the paper feed cassette control unit 205 acquires paper information 701, which was registered for each paper feed cassette at the time of receipt of the job ticket, from the paper feed cassette settings storage unit 213. At step S602, the paper feed cassette control unit 205 acquires the overwrite-designated paper feed cassette and paper information from the job ticket analyzing unit 204 and stores these in the temporary holding unit 214 as overwrite-request data 702.

At steps S603 to S607, whether paper the same as paper information in an overwrite-specify list has already been set for a paper feed cassette among the current paper feed cassettes is detected. If a paper feed cassette having the same paper information is detected, then this paper feed cassette is used as is. This processing makes it possible to eliminate an unnecessary paper switching operation.

At step S603, the paper feed cassette control unit 205 adopts the paper information of a paper feed cassette N in the overwrite-specify list as the object of processing. At step S604, whether a paper feed cassette for which both the paper type and paper size match those of the paper feed cassette N of the overwrite-specify data stored at step S602 exists among the current paper feed cassette is detected. If a paper feed cassette having the same paper type and paper size is not detected, then control shifts to processing of a paper feed cassette N+1 of the next overwrite-request data.

If the paper feed cassette is detected, on the other hand, then control proceeds to step S605 and the paper feed cassette control unit 205 stores the detected paper feed cassette and the paper information that has been registered for the paper feed cassette in the temporary holding unit 214. In this example, paper information 703, namely Cassette 2: coated paper, A4, Cassette 1: thick paper, A4 and Cassette 5: punched paper, A4, is detected successively at step S604 and is stored in the temporary holding unit 214.

Next, at step S606, the paper feed cassette control unit 205 adopts the detected paper feed cassette as one for which the registered paper has been finalized. By adopting such finalization, the paper feed cassette is excluded when processing from step S608 onward is executed. Then, at step S607, the paper feed cassette control unit 205 adopts the paper feed cassette N of the overwrite request as one for which overwrite has been finalized and excludes it from the processing of step S608 onward.

At step S608, the paper feed cassette control unit 205 applies processing to paper feed cassette N of the overwrite-request data, which has not been overwritten at steps S603 to S607 above, and to a current paper feed cassette that has not yet been finalized. Next, at step S609, the paper feed cassette control unit 205 detects whether a paper feed cassette whose paper size matches that of paper feed cassette N for which overwrite has not been performed exists in the current paper feed cassette registration information. If a paper feed cassette for which the same paper size has already been registered is detected, then control proceeds to step S610.

If such a paper feed cassette is not detected, on the other hand, then the paper size of the next paper feed cassette N+1 is detected. In this example, a paper size the same as color paper A3 for which overwrite has been requested for paper feed cassette 2, namely paper size “A3” that has been registered for Cassette 4 from among the current paper feed cassette settings, is detected.

At step S610, the paper feed cassette control unit 205 stores the combination of the detected paper feed cassette and paper information of the paper feed cassette N in the temporary holding unit 214 temporarily. In this example, paper information 704, namely Cassette 4: color paper, A3 and Cassette 6: label paper, A3, is stored successively. Next, at step S611, the paper feed cassette control unit 205 adopts the detected paper feed cassette as one for which the registered paper has been finalized and assumes that there is a paper feed cassette change. At step S612, the paper feed cassette control unit 205 adopts the paper feed cassette N, which is the object of overwrite, as one for which overwrite has been performed.

By the processing of steps S609 to S612, whether the same paper size has already been registered for a paper feed cassette is sensed and this paper feed cassette is used preferentially. As a result, the time-consuming operation of changing paper size of a paper feed cassette at the time of paper switching can be eliminated.

At step S613, the paper feed cassette control unit 205 determines whether a paper feed cassette that has not yet undergone overwrite exists among the paper feed cassettes of the overwrite-specify data. If it is determined that a paper feed cassette that has not yet undergone overwrite exists, control proceeds to step S614. On the other hand, if it is determined that all paper feed cassettes have undergone overwrite, then the processing of this flowchart is terminated.

At step S614, the paper feed cassette control unit 205 stores the remaining paper feed cassettes of the overwrite-specify data and the paper information in the temporary holding unit 214. If a designated paper feed cassette has already been finalized for registration, the paper feed cassette control unit 205 adopts paper feed cassettes for which registration has not been finalized as objects of overwrite. In this example, paper information 705 of Cassette 3: tab A4 tab is stored in the temporary holding unit 214 as is. Then, at step S615, the paper feed cassette control unit 205 assumes that a paper feed cassette that is the object of overwrite has a paper feed cassette change and terminates the processing of this flowchart.

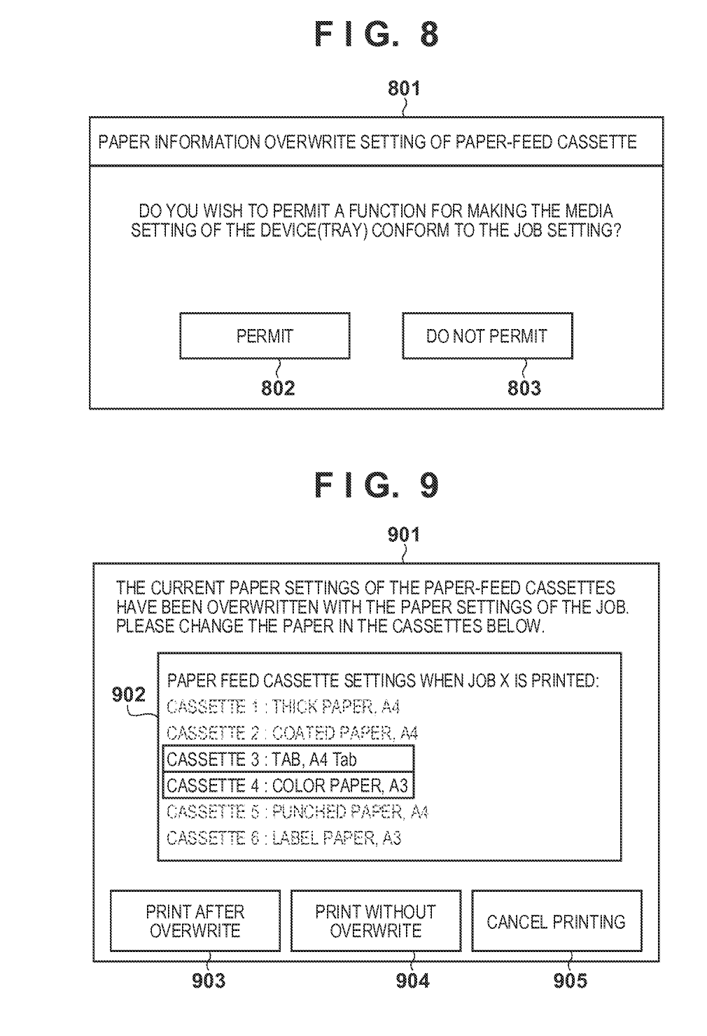

FIG. 8 is a diagram illustrating an example of a settings screen 801 for setting whether or not to permit the setting of overwrite of paper information of a paper feed cassette. In a case where paper information of a paper feed cassette is to be overwritten by the settings of a print job, the user presses a “PERMIT” button 802, which permits overwrite, on the screen 801.

Further, if the user presses a “DO NOT PERMIT” button 803 on the screen 801, processing similar to that of an ordinary print job is carried out without executing overwrite processing even in a case where a job ticket for which the paper feed cassette setting is overwrite ON.

Thus, by making it possible to make a setting on the side of the image forming apparatus that permits overwrite of paper information of a paper feed cassette, it is possible to prevent unintended overwrite processing of paper information of a paper feed cassette. As a result, the occurrence of device jamming due to mismatch between registered paper of a paper feed cassette and paper that has actually been installed can be prevented.

Described next is a notification screen displayed at the time of processing of step S506 for deciding a paper feed cassette whose paper setting is overwritten by the paper setting of the print job, and for notifying the user to switch paper. A paper feed cassette setting screen 901 shown in FIG. 9 displays paper feed cassettes used in paper feed cassette settings 902. Paper feed cassettes that do not require switching of paper are grayed-out on the screen 901. On the other hand, with regard to paper feed cassettes enclosed by the rectangles, overwrite of the paper information that has been registered for these paper feed cassettes is recommended. This indicates that it is necessary to switch the paper that has been placed in these paper feed cassettes.

If the user presses a “PRINT AFTER OVERWRITE” button 903 after the paper switching operation, printing starts in accordance with the paper feed cassettes and paper information being displayed in the paper feed cassette settings 902. Further, if the user presses a “PRINT WITHOUT OVERWRITE” button 904, then the paper feed cassette settings being displayed in the paper feed cassette settings 902 are nullified and printing starts without execution of overwrite processing of the paper feed cassettes. Furthermore, printing is cancelled and processing of this flowchart terminated by pressing a “CANCEL PRINTING” button 905.

Thus, before the start of printing, the user is notified of paper feed cassettes to which overwrite processing of the paper feed cassettes is applicable. As a result, the user can perform the paper switching operation in one lot before the start of printing. Further, since locations that do and do not require switching of paper can be ascertained at a single glance, the paper switching operation can be performed smoothly.

### Second Embodiment

In the first embodiment, the case of a print job such as VDP in which Rip While Print has been designated was described. However, in the case of a print job in which Rip Then Print is possible, the number of paper types used can be detected beforehand in accordance with the content of the print job. Further, by acquiring the number of sheets it is possible for each paper feed cassette to feed, the same paper is set beforehand in a plurality of paper feed cassettes if one type of paper used is greater than the number of sheets it is possible for one paper feed cassette to feed.

By thus setting the same paper in advance, printing can continued without the occurrence of an out-of-paper error after all of the paper that has been set in one paper feed cassette has been fed. Further, by taking the number of sheets used into consideration and executing overwrite setting processing, operating efficiency at the time of printing can be improved further.

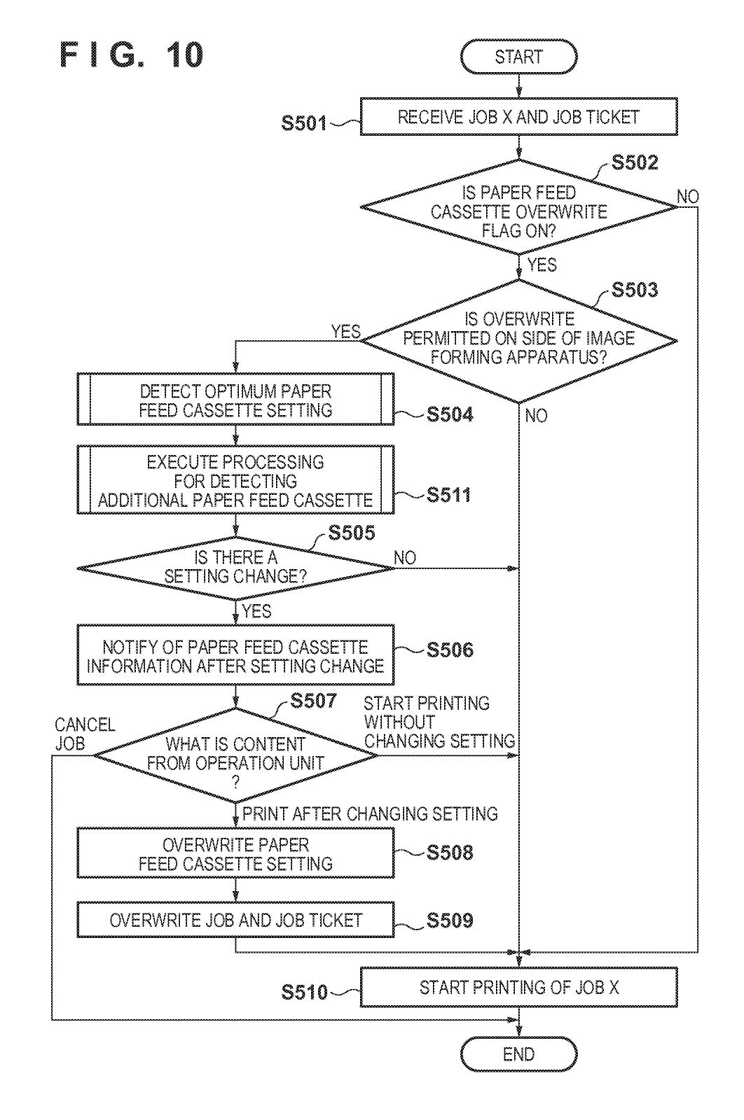

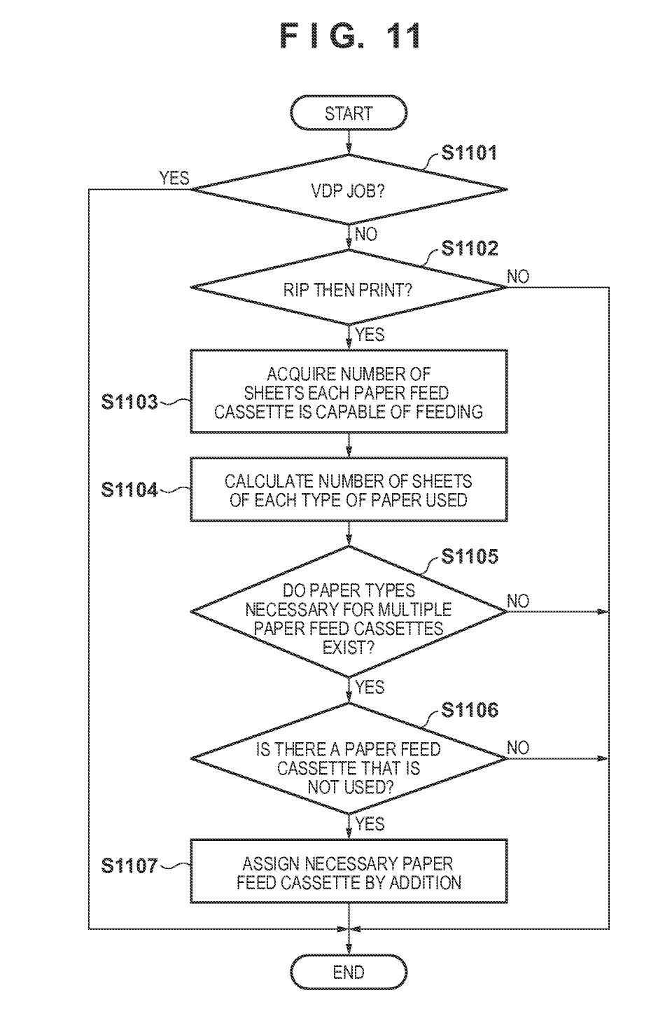

FIG. 10 is a flowchart illustrating a series of processing steps according to a second embodiment of the present invention. This flowchart is obtained by adding processing (step S511) for detecting an additional paper feed cassette to the processing of the first embodiment shown in FIG. 5. This processing for detecting an additional paper feed cassette detects whether an additional paper feed cassette is necessary or not, depending upon the content of the print job, after the processing of step S504 for detecting the optimum paper feed cassette setting. The details of processing for detecting an additional paper feed cassette will be described with reference to FIG. 11.

First, at step S1101, the job analyzing unit 206 determines whether the received print job is a VDP print job. In case of a FDP print job, processing of this flowchart is terminated. If it is determined that the print job is not a VDP print job, then control proceeds to step S1102.

At step S1102, the job analyzing unit 206 determines whether the processing designated by the print job is Rip Then Print. If Rip Then Print is determined, control proceeds to step S1103. If Rip Then Print is not determined, then the processing of this flowchart is terminated.

At step S1103, the paper feed cassette control unit 205 acquires the number of sheets it is possible for each paper feed cassette to feed. At step S1104, the job analyzing unit 206 calculates the number of sheets used of each paper type used in the print job.

Next, at step S1105, the paper feed cassette control unit 205 determines the paper feed cassette used based upon the result of detection of the optimum paper feed cassette being held in the temporary holding unit 214, and whether the number of sheets it is possible for this paper feed cassette to feed satisfies the number of sheets of paper used. If the result of the determination is that the number of sheets of paper used in the print job is greater than the number of sheets it is possible for the designated paper feed cassette to feed, then control proceeds to step S1106. However, if it is determined that the number of sheets of paper used in the print job is less, then the processing of this flowchart is terminated.

At step S1106, the paper feed cassette control unit 205 determines whether there is a paper feed cassette that is not being used based upon the result of detection of the optimum paper feed cassette. Control proceeds to step S1107 if there is a paper feed cassette that is not being used. On the other hand, if it is determined that there is no unused paper feed cassette, then the processing of this processing is terminated.

At step S1107, the paper feed cassette control unit 205 assigns the paper type used that exceeds the number of feedable sheets to the paper feed cassette detected at step S1106.

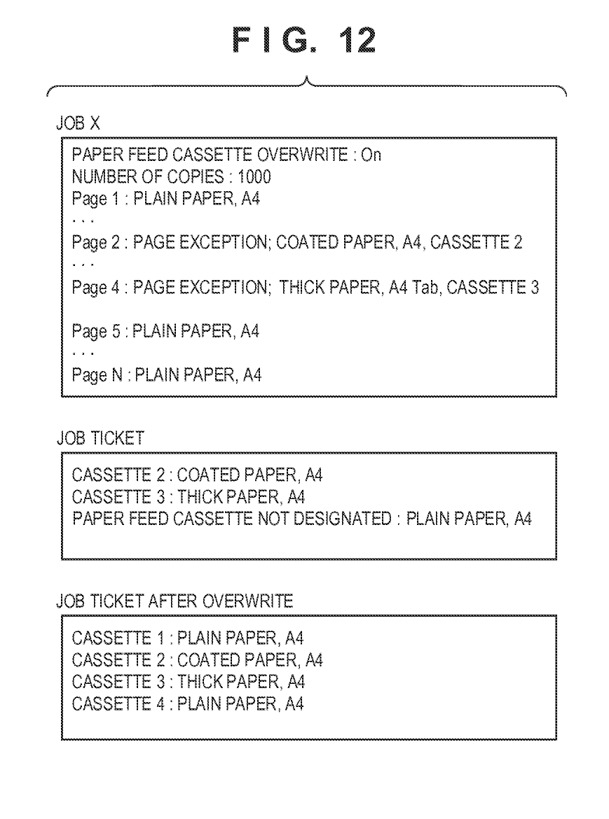

FIG. 12 is a diagram illustrating an example of a received print job X and job ticket according to the second embodiment. According to print job X, the number of copies is 1000 and plain paper, A4 is used with except for pages 2 and 4, which are exceptions. Accordingly, many sheets of A4 plain paper are required. Further, in the job ticket, only page-exception media is designated for Cassettes 2 and 3.

The number of sheets of each medium used in the print job and the number of sheets that the device is capable of feeding are taken into consideration and the job ticket after overwrite is illustrated following processing for detecting an additional paper feed cassette. The job ticket after overwrite shown in FIG. 12 specifies that A4-size plain paper is to be placed in Cassettes 1 and 4.

Thus, in a case where multiple paper feed cassette are required in the print processing of one print job, an out-of-paper error is prevented from occurring during the course of printing by placing the same paper in a plurality of paper feed cassettes beforehand. As a result, interruption of printing due to depletion of paper during the course of printing and the labor involved in adding paper can be eliminated. This makes possible a further improvement in overall productivity.

### Third Embodiment

Processing for restoring a paper feed cassette setting to that which was in effect before overwrite following the end of printing in which overwrite processing of a paper feed cassette was executed will be described as a third embodiment. This processing is applied when overwrite processing of a paper feed cassette is executed provisionally and a paper feed cassette is restored to the settings for ordinary printing.

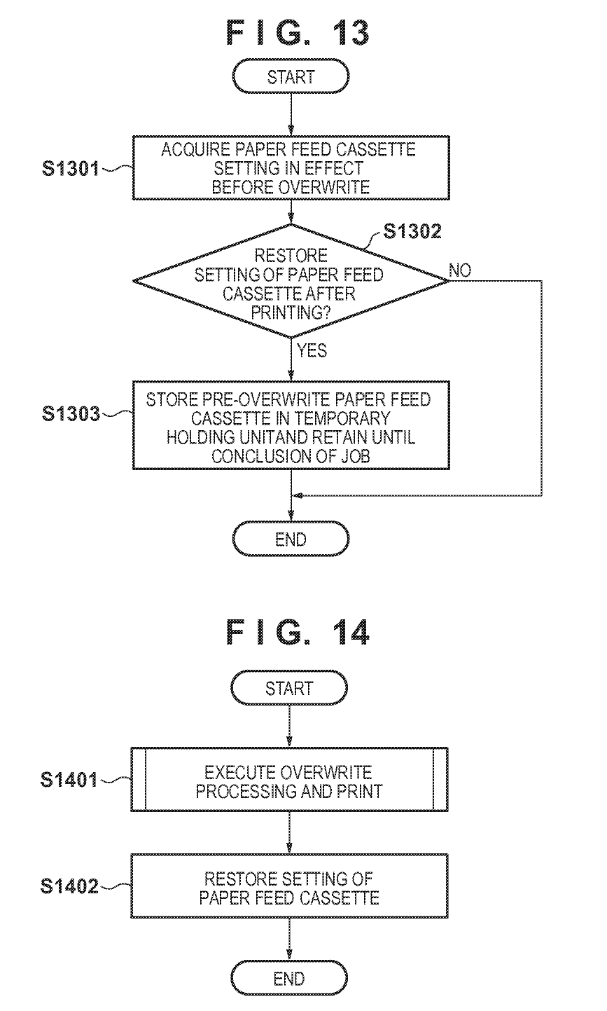

FIG. 13 is a flowchart illustrating processing for restoring a paper feed cassette setting to that which was in effect before overwrite.

Following the end of printing, the paper feed cassette control unit 205 acquires the paper feed cassette setting that was in effect before overwrite from the paper feed cassette settings storage unit 213 at step S1301. Next, at step S1302, the job analyzing unit 206 determines whether the received print job specifies that a paper feed cassette be restored, after printing, to the setting that was in effect before overwrite processing. If it is determined that restoration of paper information of a paper feed cassette to that which was in effect before overwrite is specified, control proceeds to step S1303. Here the pre-overwrite paper feed cassette is stored in the temporary holding unit 214 and is retained here until the job ends. On the other hand, if it is determined that restoration of paper information of a paper feed cassette to that which was in effect before overwrite is not specified, then the processing of this flowchart is terminated.

FIG. 14 is a flowchart illustrating processing for restoring a paper feed cassette setting to the original following print processing. First, at step S1401, overwrite processing as well as print processing is executed. At step S1402, the paper feed cassette control unit 205 acquires the paper feed cassette information being held in the temporary holding unit 214 after print processing and restores the setting of the paper information of the paper feed cassette to the state that was in effect before overwrite.

Thus, by making it possible to retain settings that were in effect before overwrite processing and to restore these settings after printing, it is possible to eliminate the labor involved in making settings for restoring paper registration when it is desired to change a setting temporarily.

In accordance with the present invention, printing can be started merely by switching the paper of paper feed cassettes before the start of printing without the user manually performing paper registration settings for the paper feed cassettes in order to set the paper required for printing. Furthermore, by deciding a paper feed cassette that requires a paper switching operation upon taking into consideration the information of other paper feed cassettes before the paper is switched, it is possible to instruct the user of the optimum paper switching operation.

Accordingly, the time required for the switching paper can be shortened and it is possible to improve user convenience and raise overall productivity.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-288553, filed Dec. 24, 2010, which is hereby incorporated by reference herein in its entirety.

What is claimed is:

1. An image forming apparatus for forming an image on paper, which has been placed in a plurality of paper feed cassettes of the image forming apparatus, in accordance with paper information concerning a paper feed cassette specified by a print job and a job ticket, comprising:
a holding unit that compares the paper information concerning the paper feed cassette specified by the job ticket and paper information that has been set for the plurality of paper feed cassettes, and to hold temporarily, as a paper feed cassette for which a change of paper is unnecessary, a paper feed cassette for which has been set paper information that matches the paper information concerning the specified paper feed cassette;
an overwrite unit that overwrites the specified paper information with respect to a paper feed cassette, from among paper feed cassettes different from the temporarily held paper feed cassette, for which has been set a paper size that matches the paper size of the specified paper information; and
a display control unit that presents a display for allowing the specified paper information to be changed to paper of the specified paper information with respect to the overwritten paper feed cassette.

2. The apparatus according to claim 1, wherein said display control unit presents a grayed-out display of information concerning the temporarily held paper feed cassette and presents a display so as to prompt the user to switch the paper of the overwritten paper feed cassette.

3. The apparatus according to claim 2, wherein said display control unit allows the user to designate whether to start printing after the paper of the overwritten paper feed cassette is changed, whether to perform printing without changing the paper of the overwritten paper feed cassette, or whether to cancel printing.

4. The apparatus according to claim 1, wherein said overwrite unit performs the overwrite in a case where permission has been given to overwrite the paper information concerning the paper feed cassette specified by the job ticket.

5. The apparatus according to claim 1, wherein said overwrite unit calculates number of sheets of paper used by the print job and, in a case where the calculated number of sheets used is greater than a number of sheets it is possible for a set paper feed cassette to feed, overwrites also another paper feed cassette, which has not been designated, as the overwritten paper feed cassette.

6. The apparatus according to claim 1, wherein following end of printing, the paper information of the overwritten paper feed cassette is restored to paper information that was in effect before overwrite.

7. A method of controlling an image forming apparatus for forming an image on paper, which has been placed in a plurality of paper feed cassettes of the image forming apparatus, in accordance with paper information concerning a paper feed cassette specified by a print job and a job ticket, said method comprising:
comparing the paper information concerning the paper feed cassette specified by the job ticket and paper information that has been set for the plurality of paper feed cassettes, and holding temporarily, as a paper feed cassette for which a change of paper is unnecessary, a paper feed cassette for which has been set paper information that matches the paper information concerning the specified paper feed cassette;
overwriting the specified paper information with respect to a paper feed cassette, from among paper feed cassettes different from the temporarily held paper feed cassette, for which has been set a paper size that matches the paper size of the specified paper information; and
presenting a display for allowing the specified paper information to be changed to paper of the specified paper information with respect to the overwritten paper feed cassette.

8. A computer-readable recording medium storing a program for causing a computer to execute the method of controlling the image forming apparatus set forth in claim 7.
